(19) United States
(12) Patent Application Publication
(10) Pub. No.: US 2026/0317061 A1
(43) Pub. Date: Oct. 15, 2026

(54) Warehouse for the storage and retrieval of goods or bundles of goods arranged on load carriers

(71) Applicant: NEDCON B.V., Doetinchem (NL)

(72) Inventor: Marc BRUINS, Ulft (NL)

(73) Assignee: NEDCON B.V., Doetinchem (NL)

(21) Appl. No.: 18/996,925

(22) PCT Filed: Jul. 25, 2023
(86) PCT No.: PCT/EP2023/070577

§ 371 Date: Jan. 17, 2025

(30) Foreign Application Priority Data
Jul. 28, 2022 (DE) 10 2022 119 000.5

(51) Int. Cl. B65G 1/04

(52) U.S. Cl. CPC B65G 1/0492; E01B 5/02; E01B 25/00; E01B 26/00

(57) ABSTRACT

A warehouse provides storage and retrieval, by a distribution vehicle, of goods or bundles of goods arranged on load carriers. The warehouse includes a frame with aisles that can be traversed by the distribution vehicle, and storage spaces for the load carriers. The storage spaces are arranged adjacently to the aisles. Rails run parallel to one another along the aisles. The distribution vehicle is guided within the rails by rollers. Each rail has two or more rail elements, each forming a section of a running surface for the rollers of the distribution vehicle. The mutually facing end faces of adjacent rail elements have a distance to each other, and at least one end face of at least one rail element is slanted. A wedge-shaped compensating element is arranged between the end faces. The compensating element forms a section of the running surface and lies flush against the end faces.

### CROSS-REFERENCE TO RELATED APPLICATION

This application is a national stage application, filed under 35 U.S.C. § 371, of International Patent Application PCT/EP2023/070577, filed on Jul. 25, 2023, which claims the benefit of German Patent Application DE 10 2022 119 000.5, filed on Jul. 28, 2022.

### TECHNICAL FIELD

The present disclosure relates to a warehouse configured for storing and retrieving, by means of a distribution vehicle, goods or bundles of goods arranged on load carriers. The warehouse has a rack. The rack has aisles, along which the distribution vehicle can travel, and has storage spaces, arranged adjacent to the aisles, for the load carriers. Arranged along the aisles are rails which run parallel to each other and within which the distribution vehicle is guided via rollers of the distribution vehicle. A respective rail has two or more rail elements, each forming a portion of a running surface for the rollers of the distribution vehicle.

### BACKGROUND

Warehouses of this type are used to place load carriers with goods or bundles of goods arranged thereon in the storage spaces or to remove these load carriers from the storage spaces, in particular in a fully automatic manner, by means of the distribution vehicle. Such warehouses frequently have a plurality of floors or levels, each being divided into aisles and storage spaces. A warehouse may thus extend over a plurality of stories or story heights and may cover, for example, a floor area of several 100m².

The rail elements have the customary manufacturing tolerances with regard to their length. This may cause adjacent rail elements to have a distance between their end faces, with the result that a slot or groove is formed in the running surface. When the distribution vehicle rolls over this groove, a shock is transmitted into the distribution vehicle, which may generate noise and, in the longer term, cause damage to the components of the distribution vehicle. Furthermore, shock stresses of this type may cause goods or bundles of goods transported on a load carrier by the distribution vehicle to shift out of place, sustain damage or fall off. Furthermore, manufacturing tolerances affecting the length of the rail elements may limit the possibility of assembling the rack precisely. For example, the manufacturing tolerances in the longitudinal direction may accumulate in such a way that the rail elements become offset in the region of intersecting aisles.

Measures to reduce noise and vibrations in the region of successive rail elements in such a warehouse are already known from EP 3 699 112 B1 and DE 10 2014 114 978 A1.

### SUMMARY

The present disclosure improves a warehouse of the type mentioned at the outset, which makes it possible to operate a distribution vehicle in a safe and wear-free manner and allows precise assembly of the rack.

This is achieved by a warehouse as claimed.

The disclosure relates to a warehouse configured for storing and retrieving, by means of a distribution vehicle (shuttle), goods or bundles of goods arranged on load carriers, the warehouse having a rack, wherein the rack has aisles, along which the distribution vehicle can travel, and has storage spaces, arranged adjacent to the aisles, for the load carriers, wherein arranged along the aisles are rails which run parallel to each other and within which the distribution vehicle is guided via rollers of the distribution vehicle, and wherein a respective rail has two or more rail elements, each forming a portion of a running surface for the rollers of the distribution vehicle. The warehouse is distinguished in that mutually facing end faces of adjacent rail elements are at a distance from each other, wherein at least one end face of at least one rail element is beveled, and wherein a wedge-shaped compensation element, which forms a portion of the running surface and contacts the end faces, is arranged in the distance between the end faces. The compensation element may contact the end faces so as to be, in particular, flush with the latter.

The compensation element makes it possible to compensate for length tolerances of the rail elements. Due to its wedge shape, the compensation element can compensate for both oversized dimensions, i.e., if the rail elements are too long with respect to their length, and undersized dimensions, i.e., if the rail elements are too short with respect to their length. This is because the wedge shape of the compensation element makes it possible to bridge different distances between the end faces of the rail elements by moving the compensation element transversely.

According to one embodiment of the warehouse, it may be provided that both mutually facing end faces of the adjacent rail elements are beveled. For example, the rail elements may be, in particular, mirror-symmetrical to a plane running transversely to the longitudinal extent of the rail elements. According to alternative embodiments of the warehouse, it may be provided that only one end face of a rail element is beveled, while an end face, formed at an end remote from the beveled side, of the rail element is not beveled.

It may be provided that the mutually facing end faces of the adjacent rail elements delimit a wedge-shaped recess, in which the compensation element is positioned, wherein a wedge angle of the recess corresponds to a wedge angle of the compensation element. The shape of the compensation element is therefore adapted to the shape of the mutually facing end faces so that, in particular, flush contact can be achieved in a simple manner between the rail elements and the compensation element arranged between the rail elements.

At least one beveled end face of the rail element may enclose an angle, relative to a longitudinal extent or longitudinal axis of the rail, which is not equal to 90°. In particular, both mutually remote ends of each rail element may have a beveled end face, which in each case encloses an angle, relative to a longitudinal extent or longitudinal axis of the rail, which is not equal to 90°.

The compensation element may have mutually remote end faces, via which the compensation element contacts the end faces of the rail elements.

At least one beveled end face of the compensation element may enclose an angle, relative to a longitudinal extent or longitudinal axis of the rail, which is not equal to 90°. In particular, both mutually remote end faces of the compensation element may enclose an angle, relative to a longitudinal extent or longitudinal axis of the rail, which is not equal to 90°.

The compensation element may have a mirror-symmetrical basic shape. This allows a compensation element which is simple to produce and fit to be specified.

According to one embodiment of the warehouse, it may be provided that the compensation element has a central portion which contacts, at least partially, the end faces of the rail elements, wherein the compensation element has at least one tab which adjoins the central portion and projects beyond a width of the rail. The tab may be used for handling the compensation element during the fitting and/or removal of the compensation element.

In particular, it may be provided that the compensation element has two mutually remote tabs which adjoin the central portion and project beyond the width of the rail. These tabs may be used to fix the compensation element in the transverse direction.

Alternatively or additionally, it may be provided that at least one tab of the compensation element is narrower than the central portion. The narrower shape of the tab improves handling of the compensation element while at the same time minimizing the amount of material used and the weight.

In order to ensure that the distribution vehicle rolls over the compensation element as smoothly as possible, it may be provided that the portion of the running surface formed by the compensation element is arranged at the same height as the portions of the running surface formed by the rail elements. In particular, the portion of the running surface formed by the compensation element and the portions of the running surface formed by the rail elements may transition into one another without discontinuities, i.e., with flush upper sides.

### BRIEF DESCRIPTION OF THE DRAWINGS

The invention is described in greater detail below on the basis of drawings which illustrate exemplary embodiments. In the schematic drawings:

FIG. 1 shows a plan view of a detail of a level of the warehouse;

FIG. 2 shows a plan view of a detail of a rail, without a compensation element;

FIG. 3 shows a plan view of the detail of the rail from FIG. 2, with a compensation element;

FIG. 4 shows the compensation element in a further position;

FIG. 5 shows the compensation element in a further position;

FIG. 6A shows a plan view of the compensation element;

FIG. 6B shows a plan view of a further compensation element; and

FIG. 7 shows a plan view of a detail of a rail, without a compensation element.

### DETAILED DESCRIPTION

FIG. 1 shows a plan view of a detail of a storage level E of a warehouse 1. The warehouse 1 has a plurality of storage levels E of this type, which are arranged above one other, as seen perpendicularly to the plane of the image, i.e., in the vertical direction.

The warehouse 1 is configured for storing and retrieving, by means of a distribution vehicle 4 (shuttle), goods 3 or bundles 3 of goods arranged on load carriers 2.

The warehouse 1 has a rack 5, which forms the static basic construction of the warehouse.

The rack 5 has aisles 6, along which the distribution vehicle 4 can travel, and storage spaces 7, arranged adjacent to the aisles 6, for the load carriers 2. The storage spaces 7 are indicated by the broken lines, which show a grid-like arrangement of the storage spaces 7.

Rails 8, which run parallel to each other, are arranged along the aisles 6. As shown in the schematic view in FIG. 1, the aisles 6 and their rails 8 intersect in the region of intersections 9.

The distribution vehicle 4 is guided within the rails 8 via its rollers 10.

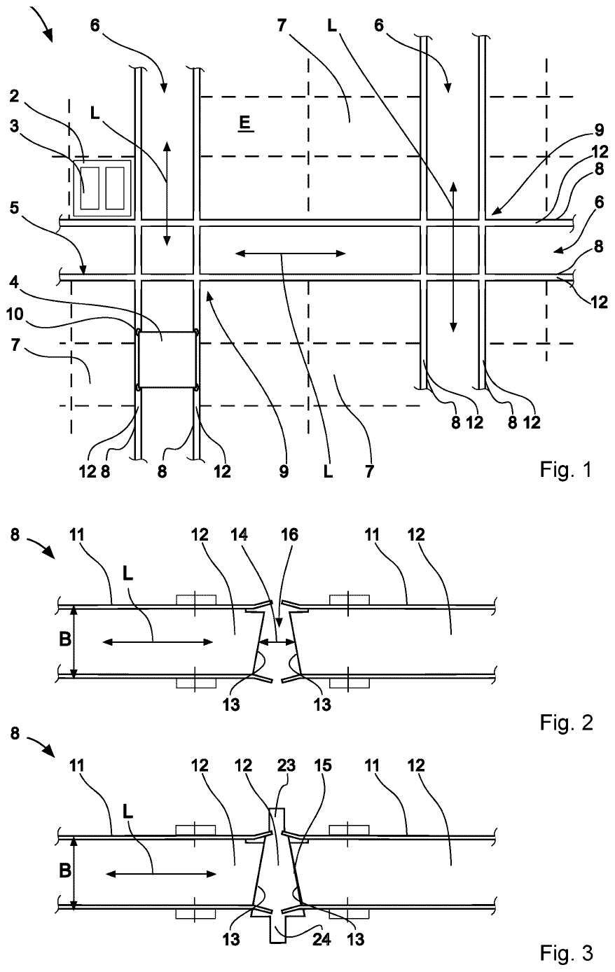

Each rail 8 has two or more rail elements 11, each forming a portion of a running surface 12 for the rollers 10 of the distribution vehicle 4 (FIG. 2).

As shown in FIG. 2, mutually facing end faces 13 of successive rail elements 11 are at a distance 14 from each other. In the present case, both end faces 13 of the adjacent rail elements 11 are beveled. In this document, “beveled” means that the end face 13 in question does not run at right angles, but rather runs obliquely to the longitudinal direction L of the rail 8. The distance 14 thus decreases, as seen over a width B of the rail elements 11.

Arranged in the distance between the mutually facing end faces 13 of the adjacent rail elements 11 is a wedge-shaped compensation element 15, which forms a portion of the running surface 12 and contacts the end faces 13 of the adjacent rail elements 11 so as to be flush therewith (FIG. 3).

The compensation element 15 thus bridges the distance 14 formed between the mutually facing end faces 13 of the adjacent rail elements 11 and fills this distance, so that a substantially closed running surface 12 is formed for the rollers 10 of the distribution vehicle 4.

In the present case, the mutually facing end faces 13 of the adjacent rail elements 11 delimit a wedge-shaped recess 16, in which the compensation element 15 is positioned. A wedge angle 17 of the recess 16 corresponds to a wedge angle 18 of the compensation element 15, wherein the wedge angles 17, 18 are shown in FIGS. 6 and 7.

FIG. 3 shows the compensation element 15 in its final fitted state between the rail elements 11, wherein in the example shown in FIG. 3, the rail elements 11, as seen in their longitudinal direction L, each have exactly the desired dimensions intended. In this case, as seen in a direction transverse to the longitudinal direction L, the compensation element 15 is positioned substantially centrally between the rail elements 11.

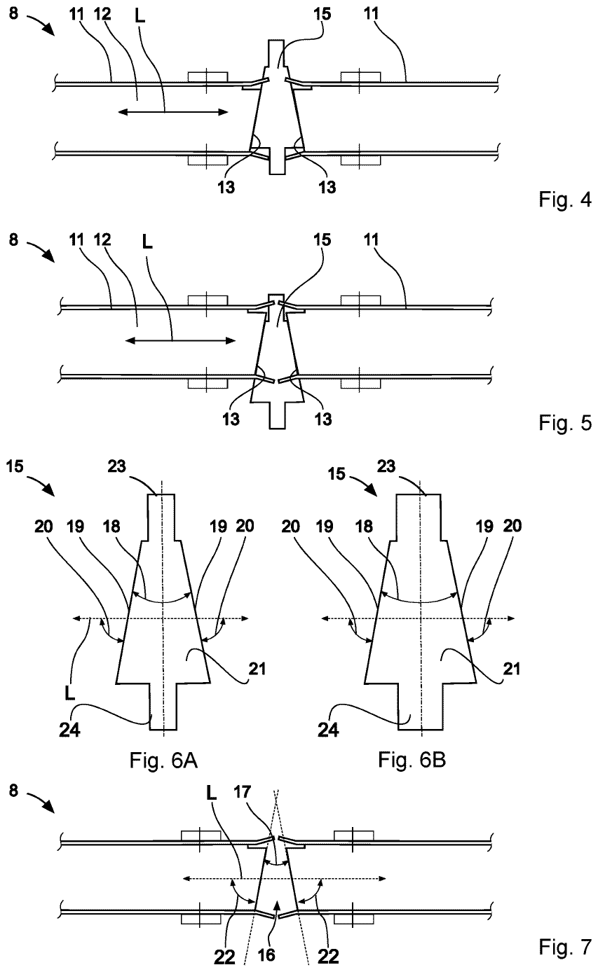

FIG. 4 shows the compensation element 15 in its final fitted state between the rail elements 11, wherein in the example shown in FIG. 4, the rail elements 11, as seen in their longitudinal direction L, have undersized dimensions, i.e., they are too short. In this case, the compensation element 15 is shifted further into the wedge-shaped recess 16 formed between the end faces 13 in order to bridge the distance between the end faces 13, this distance being greater than in FIG. 3, and to provide a substantially closed running surface 12, despite the insufficient length dimensions of the rail elements 11.

FIG. 5 shows the compensation element 15 in its final fitted state between the rail elements 11, wherein in the example shown in FIG. 5, the rail elements 11, as seen in their longitudinal direction L, have oversized dimensions, i.e., they are too long. In this case, the compensation element 15 is shifted outward from the wedge-shaped recess 16 formed between the end faces 13 in order to bridge the distance between the end faces 13, this distance being smaller than in FIGS. 3 and 4, and to provide a substantially closed running surface 12, despite the excessive length dimensions of the rail elements 11.

FIG. 6A shows a plan view of the compensation element 15 alone. The compensation element 15 has mutually remote end faces 19, each of which run in a straight manner and via which the compensation element 15, in its final fitted state, contacts the end faces 13 of the rail elements 11 in a linear manner.

The compensation element 15 is mirror-symmetrical.

The beveled end faces 19 of the compensation element 15 enclose an angle 20, relative to a longitudinal extent L of the rail 8, which is not equal to 90°. In the present example, the angle 20 is approximately 80° and the wedge angle 18 is approximately 20°. According to alternative exemplary embodiments, it may, for example, be provided that the wedge angle is up to approximately 45°.

FIG. 6B shows an alternative embodiment of the compensation element 15, which differs from the compensation element 15 in FIG. 6A in that it has a wider central portion 21. For example, the warehouse 1 may have, for example, two or more compensation elements 15 which have the same angle 20 and wedge angle 18, but have central portions 21 of different widths in order also to bridge greater distances between the rail elements 11 where necessary.

FIG. 7 shows the angles 22 formed between the end faces 13 of the rail elements 11 and the longitudinal direction L, and also the wedge angle 17 delimited by the end faces 13. The angles 20 and 22 are identical in size and/or have the same value.

The angles 17 and 18 are identical in size and/or have the same value.

The compensation element 15 has the central portion 21 which contacts, at least partially, the end faces 13 of the rail elements 11. The compensation element 15 as a whole is a flat sheet metal strip of preferably uniform material thickness. Two tabs 23, 24, which project beyond the width B of the rail 8 and adjoin the central portion 21, are constituent parts of the flat sheet metal strip. In a plan view, the tabs 23, 24 are preferably narrower than the central portion 21.

The compensation element 15 may be fixed in the transverse direction by clamping by means of the tabs 23, 24 or by means of only one of the tabs 23, 24. The underside of the tab 23, 24 in question is supported on a surface located on a component of the rack 5. At the same time, the tab in question is clamped against the surface by the application of pressure on the upper side of the tab. This pressure on the upper side of the tab 23, 24 may be applied, for example, by a screw and preferably by the underside of a screw head.

Alternatively, the compensation element 15 may be adhesively bonded to a surface, arranged underneath the former, of a component of the rack 5.

### LIST OF REFERENCE SIGNS

1 warehouse
2 load carrier
3 goods/bundles of goods
4 distribution vehicle
5 rack
6 aisle
7 storage space
8 rail
9 intersection
10 roller
11 rail element
12 running surface
13 end face
14 distance
15 compensation element
16 recess
17 wedge angle
18 wedge angle
19 angle
20 angle
21 central portion
22 angle
23 tab
24 tab
B width
L longitudinal extent/longitudinal direction/longitudinal axis

1.-10. (canceled)

11. A warehouse,
wherein the warehouse is configured for storing and retrieving, by a distribution vehicle (4), goods (3) or bundles of goods (3), the goods (3) or bundles of goods (3) being arranged on load carriers (2),
wherein the warehouse comprises a rack (5),
wherein the rack (5) has aisles (6),
wherein the distribution vehicle (4) can travel along the aisles (6),
wherein the warehouse has storage spaces (7) for the load carriers (2), the storage spaces (7) being arranged adjacent to the aisles (6),
wherein rails (8) are arranged along the aisles (6),
wherein the rails (8) run parallel to each other and
wherein the distribution vehicle (4) is guided via rollers (10) of the distribution vehicle (4) within the rails (8), and
wherein a respective one of the rails (8) has two or more rail elements (11), each forming a portion of a running surface (12) for the rollers (10) of the distribution vehicle (4),
wherein mutually facing end faces (13) of adjacent ones of the two or more rail elements (11) are at a distance (14) from each other,
wherein at least one of the end faces (13) of at least one of the two or more rail elements (11) is beveled, and
wherein a wedge-shaped compensation element (15) is arranged between the end faces (13), and
wherein the wedge-shaped compensation element (15) forms a portion of the running surface (12) and contacts the end faces (13).

12. The warehouse as claimed in claim 11,
wherein both mutually facing end faces (13) of the adjacent ones of the two or more rail elements (11) are beveled.

13. The warehouse as claimed in claim 11,
wherein the mutually facing end faces (13) delimit a wedge-shaped recess (16), in which the compensation element (15) is positioned, and
wherein a wedge angle (17) of the wedge-shaped recess (16) corresponds to a wedge angle (18) of the compensation element (15).

14. The warehouse as claimed in claim 11,
wherein at least one beveled end face (13) of the rail element (11) encloses an angle (22) relative to a longitudinal extent (L) of the rail (8), and
wherein the angle (22)is not equal to 90°.

15. The warehouse as claimed in claim 11,
wherein the compensation element (15) has mutually remote end faces (19), and
wherein the compensation element (15) contacts the end faces (13) of the rail elements (11) via the mutually remote end faces (19) of the compensation element (15).

16. The warehouse as claimed in claim 15,
wherein at least one beveled end face (19) of the compensation element (15) encloses an angle (20) relative to a longitudinal extent (L) of the rail (8), and wherein the angle (20) is not equal to 90°.

17. The warehouse as claimed in claim 11,
wherein the compensation element (15) has a mirror-symmetrical shape.

18. The warehouse as claimed in claim 11,
wherein the compensation element (15) has a central portion (21) which contacts, at least partially, the end faces (13) of the rail elements (11), and
wherein the compensation element (15) has at least one tab (23, 24) which adjoins the central portion (21) and projects beyond a width (B) of the rail (8).

19. The warehouse as claimed in claim 18,
wherein the compensation element (15) has two mutually remote tabs (23, 24) which adjoin the central portion (21) and project beyond the width (B) of the rail (8)
and/or
wherein at least one tab (23, 24) of the compensation element (15) is narrower than the central portion (21).

20. The warehouse as claimed in claim 11,
wherein the portion of the running surface (12) formed by the compensation element (15) is arranged at the same height as the portions of the running surface (12) formed by the rail elements (11),
wherein the portion of the running surface (12) formed by the compensation element and the portions of the running surface (12) formed by the rail elements (11) transition into one another, in particular without discontinuities.
